(19) United States
(12) Patent Application Publication
(10) Pub. No.: US 2013/0130255 A1
(43) Pub. Date: May 23, 2013

(54) OPTICAL MAPPING OF GENOMIC DNA

(71) Applicants: Peter Dedecker, Herent (BE); Johan Hofkens, Oud-Heverlee (BE); Jun-Ichi Hotta, Sapporo (JP); Robert Neely, Carlton-in-Cleveland (GB)

(72) Inventors: Peter Dedecker, Herent (BE); Johan Hofkens, Oud-Heverlee (BE); Jun-Ichi Hotta, Sapporo (JP); Robert Neely, Carlton-in-Cleveland (GB)

(21) Appl. No.: 13/701,628

(22) PCT Filed: Jun. 1, 2011
(86) PCT No.: PCT/BE2011/000035

§ 371 Date: Dec. 3, 2012

Related U.S. Application Data
(60) Provisional application No. 61/459,306, filed on Dec. 9, 2010.

(30) Foreign Application Priority Data
Jun. 4, 2010 (GB) 1009332.6
Jun. 30, 2010 (GB) 1011066.0
Sep. 27, 2010 (GB) 1016194.1
Dec. 13, 2010 (GB) 1021026.8
Dec. 20, 2010 (GB) 1021491.4

(51) Int. Cl. G01N 21/64

(52) U.S. Cl. CPC G01N 21/6486
USPC 435/6.11; 435/287.2

(57) ABSTRACT

A method for single-molecule optical DNA profiling using an exceptionally dense, yet sequence-specific coverage of DNA with a fluorescent probe, using a DNA methyltransferase enzyme to direct the DNA labeling, followed by molecular combing of the DNA onto a polymer-coated surface and subsequent sub-diffraction limit localization of the fluorophores. The result is a ‘DNA fluorocode’; a simple description of the DNA sequence, with a maximum achievable resolution of less than 20 bases, which can be read and analyzed like a barcode. The method generates a fluorocode for genomic DNA from the lambda bacteriophage using a DNA methyltransferase to direct fluorescent labels to four-base sequences reading 5′-GCGC-3′. A consensus fluorocode is constructed that allows the study of the DNA sequence at the level of an individual labeling site and is generated from a handful of molecules and entirely independently of any reference sequence.

### BACKGROUND OF THE INVENTION

A. Field of the Invention The present invention relates generally to polynucleotide mapping with nanometre resolution and, more particularly to a system and method of optical mapping of genomic DNA with nanometre resolution based on a DNA fluorocode.

Several documents are cited throughout the text of this specification. Each of the documents herein (including any manufacturer's specifications, instructions etc.) are hereby incorporated by reference; however, there is no admission that any document cited is indeed prior art of the present invention.

B. Description of the Related Art

Current DNA sequencing methods are capable of reading only relatively short fragments of DNA, up to 1500 bases in length. However, in a human genome, there are 6 billion bases. So in order to read the entire genome at least 4 million of these short sequence reads are required. Hence, perhaps the most challenging aspect of the genomic sequencing, is not reading the DNA but assembling the short read fragments into a complete map of the genome. The situation is complicated significantly by the presence of a large number of repeats in the genomic DNA. Such repeats can be of the order of one thousand times longer that the DNA reads and under such circumstances, reliable genome assembly is impossible. Genomic repeats (known as copy number variations) account for a significant proportion of the human genome (around 12%) and cause important genetic disorders, such as schizophrenia and congenital heart defects.

DNA optical mapping is a critical component of the process of genome assembly. A single DNA molecule can be mapped on the scale of thousands up to hundreds of thousands of bases in length. Whilst the map does not provide a base-by-base sequence of the DNA molecule, it can be used as a template upon which to build the short DNA reads to create a complete genomic sequence.

In the current state of the art, a DNA molecule is stretched onto a functionalized glass surface and then an enzyme (a restriction enzyme), which typically recognizes a six-base sequence, is applied to the DNA. The enzyme cuts the DNA at these sequences. Subsequent staining of the DNA with a non-specific fluorescent dye allows the visualization of the resulting DNA fragments, which can be sized. These fragments are typically 20000 bases long but can be as short as 700 bases.

An alternative approach to generate such a map is to fluorescently stain the DNA molecule at a specific location. This is currently done using a nicking enzyme, which cuts just one strand of the DNA double helix. Subsequent treatment of the DNA using a polymerase enzyme extends the nicked DNA strand and this allows the incorporation of a fluorescently labelled base to the DNA. This method results in a map at similar resolution to the optical map using restriction enzymes.

Thus, there is a need in the art for polynucleotide e.g. DNA or RNA mapping with an improved resolution for instance less than 300 bases, even less than 100 bases or even less than 50 bases for instance between 260 and 19 bases. Present invention solves the problems to fulfil such need.

By present invention we label the DNA using a DNA methyltransferase enzyme and some synthetically prepared cofactors. The use of the methyltransferase is non-destructive and allows the targeting of the fluorescent labels to short DNA sequences of only four bases in length. Hence, on average we can position one fluorophore every 256 bases and we can resolve a distance between fluorophores of just 20 bases. Such high resolution is possible thanks to the unique combination of the labelling method and the analysis software that we developed. Our analytical approach allows the reconstruction of the DNA molecule and its display as a ‘fluorocode’; an optical map with unprecedented resolution. This improvement in resolution and fluorophore coverage of the DNA is significant since it enables the study of DNA sequence on the scale of the genome, with genetic resolution and at the single molecule level for the first time. Potential applications include DNA profiling for forensic science, genome assembly, the study of copy number variations and of heritable diseases and the identification of bacterial organisms.

### SUMMARY OF THE INVENTION

The invention concerns a single-molecule optical polynucleotide mapping and sequencing technology. Sequence-specifically labelled polynucleotide with high labelling density are subjected to photobleaching (fading), to photoswitching or to another stochastic photophysical process such that fluorescence emission from individual fluorophores is quantified or measured. A software program allows to determine the position of the individual fluorophore labels with sub diffraction limit precision and translate the fluorophore label position to a location to the polynucleotide molecules by comparison of the image to one or more reference molecules or standards. Only those fluorophores with a standard deviation that is less than the diffraction limit for the light emitted from said fluorophore are used to produce an optical map with sub-diffraction limit resolution and align it to the DNA to derive the fluorocode. The method is particular suitable for linearized DNA.

DNA can be stretched out for linear analysis on surfaces or in nanochannels by nanofluidic methods. For instance DNA can be linearized by fluidic devices with sub-micrometer dimensions for instance with a microchannel with an entropic trap or with an array of entropic traps for instance sub-100 nm constriction adapted to cause DNA molecules to be entropically trapped. The length-dependent escape of DNA from such trap enables a band separation of the DNA molecule(s). DNA with lengths can be moved electrokinetically into a nanofluidic nanoslit array. Such microchannel with an entropic trap can comprise alternating deeper (well) and shallower (nanoslit) regions to be more effective for separating DNA in the kbp range by entropic trapping and to linearize the DNA [Separation of long DNA molecules in a microfabricated entropic trap array,” J. Han and H. G. Craighead, Science, 288, 1026-1029 (2000)]. Such nanochannels can be fabricated as well as prepared with soft lithography for easier flow (Tegenfeldt, J. O., et al. (2004). “Micro- and nanofluidics for DNA analysis.” Anal Bioanal Chem 378: 1678 and Cao, H., et al. (2002). “Fabrication of 10 nm enclosed nanofluidic channels.” Applied Physics Letters 81: 174). Particular suitable for containing nanoslits or nanoslit arrays are fused silica nanofluidic devices containing either nanoslit arrays to separate and linearise the specifically labelled polynucleotide under an electric field.

Such sequence-specifically labelled polynucleotide is hereby generated by reacting said polynucleotide with sequence specific binding enzymes and their cofactor. For instance DNA is reacted with methyltransferase and an s-adenosyl-L-methionine analogue to induce a covalent modification of polynucleotide at target locations determined by the specificity of the polynucleotide methyltransferase enzyme. We do not use labelled cofactors (unlabelled cofactors). The purified polynucleotide can subsequently be incubated with a fluorescent or fluorophore label to give sequence-specific labelling of the polynucleotide.

A particular advantage of optical mapping is the lack of necessity for a priori targeting of specific DNA sequences. This enables a holistic approach to genome analysis and, in theory, makes mapping the genome possible in a single experiment and without any prior knowledge of the DNA sequence. Using a fluorescent labelling approach to map genomic DNA has distinct advantages over optical mapping using restriction enzymes. We have shown that these include the use of a far higher density of targeted (labelled) sites on the DNA and improved precision in determining the location of these sites over any prior art method. The fluorocode, which is formed by localizing the selected fluorophores enables the construction of an optical map of genomic material with unrivalled detail and DNA motifs on the scale of the single gene and that the sequence-specifically labelled polynucleotide has a mapping resolution of less than less than 50 bases. Yet there are significant advances still to be made using the fluorocoding approach. For example, multi-colour labelling of the DNA using two or more methyltransferases to direct the labelling will create a colour fluorocode that allows a high degree of confidence in the analysis and interpretation of the fluorocode. Such an approach enables the optical readout of a DNA molecule flowing through a nanoslit.

The invention is defined in independent claim 1. The invention may take form in various components and arrangements of components, and in various steps and arrangements of steps.

The invention relates to a method for sub-diffraction limit precision mapping of sequence specifically fluorophore labeled polynucleotide (e.g. a DNA), the method being characterized in that 1) individual fluorophore labels along a linear polynucleotide, are isolated (e.g. by photobleaching, by photoswitching or by another stochastic photophysical process) and 2) the position of individual fluorophore labels is determined by a processor with software assisted measurement system and/or control algorithm adapted to measure the fluorescence emission signal followed by 3) translation of the aforementioned fluorophore label positions to a location on said polynucleotide by comparison of the image to one or more reference molecules or standards. This processor can in an embodiment comprises a program to fit the position of each of the fluorophores along the polynucleotide (e.g. DNA) molecule with sub-diffraction-limit precision. In this context an embodiment of present invention concerns a processor that models and fits the emission from a fluorophore (observable as a diffraction-limited spot) and in particular this can concern a processor that models and fits the emission from a fluorophore (observable as a diffraction-limited spot) using a two-dimensional Gaussian profile. Furthermore in a preferred embodiment this processor extracts the contribution of every emitter in the movie. Hereby the integration times is in a particular embodiment 200-500 milliseconds.

The object of the present invention is also realized in that the invention provides fluorophore positioning which can be convolved with a Gaussian point spread function to give the projected position of each of the fluorophores on a line, in an embodiment the fluorophore positions or individual polynucleotide (e.g. DNA) molecules are visualized to create a fluorocode and whereby an intensity profile along each fluorocode is generated in order to align a fluorocode from an individual molecule (data) to another fluorocode. The two intensity profiles can hereby be aligned by laterally shifting and stretching one profile to fit the other profile. In a particular embodiment the stretching factor applied to the reference map is hereby allowed to vary between 1.2 and 2.0 and this and the lateral shift parameter are optimized by maximizing the output from the convolution of the two intensity profiles. These fluorophore positions or individual polynucleotide (e.g. DNA) molecules can be monitored by a Matlab code.

An embodiment of the method according to the invention is characterized in that the fluorophore labels are excited and fluorescence emission quantified or measured in relation to exposure time and intensity of excitation. Particularly suitable for the method of present invention are sequence specifically fluorophore labeled polynucleotide comprises high density fluorophore labeling which concerns a fluorophore positioned every x bases, whereby x is between 260 and 19 bases; or the sequence-specifically labeled polynucleotide has a mapping resolution of less than 300 bases; or the sequence-specifically labeled polynucleotide has a mapping resolution of less than 100 bases; or the sequence-specifically labeled polynucleotide has a mapping resolution of less than less than 50 bases; or fluorophore is positioned every 256 bases at average or every 250 bases at average; or the sequence-specifically labeled polynucleotide has a high labeling density of one fluorophore every 250 bases. Hereby fluorophores are localized with a precision that has a standard deviation that is less 250 nm.

A further embodiment of the above described methods of present is characterized in that the DNA polynucleotide is amplified by a DNA polymerase and the fluorocode of the amplified DNA is compared with that of the native genomic DNA to derive a map of the methylation status of the genomic DNA.

An embodiment of the method according to the invention is characterized in that the fluorophore labels are excited by a laser. In yet another embodiment the method according to the invention is characterized in that the fluorophore label excited on a single DNA molecule and fluorescence emission quantified or measured. Another embodiment of the method according to the invention is characterized in that the fluorophore label's emission is detected via an optical filter and an emission band pass filter.

In yet another aspect of present invention the processor has a computer readable medium tangibly embodying computer code executable on a processor. The processor can furthermore comprises a memory for storing the information signals and at least one transmitter for transmitting processed information signals to a display means. A specific embodiment of the method according to the invention is characterized in that a film of the photobleaching of the fluorophores on a single polynucleotide is stored in the memory.

In an embodiment of the method of present invention according to any one of the previous described embodiments, the method further comprises generating a sequence-specifically labelled polynucleotide (e.g. DNA) by reacting said polynucleotide with a sequence specific enzyme to induce a covalent modification of polynucleotide at target locations determined by the specificity of the sequence specific enzyme and by incubation of the polynucleotide and sequence specific enzyme with an unlabeled cofactor of said the sequence specific enzyme until a polynucleotide enzyme-catalyzed covalent attachment of a functional group to the polynucleotide is achieved which after purification is incubated with a fluorescent or fluorophore label and imaged to isolate the individual fluorophore labels (for instance by photobleaching, by photoswitching or by another stochastic photophysical process). Specific embodiments to comprise: the sequence specific enzyme is methyltransferase and its cofactor is an unlabeled analogue of s-adenosyl-L-methionine; the density of labeling is tunable, depending on the methyltransferase enzyme used to carry out the reaction; the methyltransferase has been mutated to alkylate DNA using an unlabeled analogue of s-adenosyl-L-methionine.

The method according to any one of the previous claims, whereby the purified labeled polynucleotide is deposited on a surface.

According to an embodiment of the present invention, the purified labeled polynucleotide is linearized in a nanoslit. According to an other embodiment of the present invention, the purified labeled polynucleotide is deposited on a polymer coated surface. Hereby the purified labeled polynucleotide can be deposited on a PMMA-coated surface such that the DNA molecule is extended beyond its solution phase contour length. Such surface can be a coverslip. Such coverslip can be PMMA-coated. Hereby the purified labeled polynucleotide is linearized on the surface.

In a special embodiment, the fluorophore labels are excited by a laser. In another special embodiment the polynuceotide (e.g. DNA) are foreseen with multi-color labeling of the polynuceotide (e.g. DNA) using two or more methyltransferases.

The methods of present invention allow various uses. Special embodiments are: The use for DNA profiling, for instance for forensic science; the use for genome assembly; the use for the study of copy number variations; the use for the study of the methylation status; the use for methylation profiling; the use for the study of heritable diseases or the use for description of the DNA sequence, with a maximum achievable resolution of less than 20 bases.

Another special embodiment of present invention is kit comprising a DNA methyltransferase, a DNA methyltransferase cofactor and a fluorophore label of present invention for carrying the methods of present invention.

Another special embodiment of present invention is a polynucleotide (e.g. DNA) molecular diagnostic testing apparatus, adapted for carrying out a method of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Thus, the claims following the detailed description are hereby expressly incorporated into this detailed description, with each claim standing on its own as a separate embodiment of this invention.

### DETAILED DESCRIPTION OF EMBODIMENTS OF THE INVENTION

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

Several documents are cited throughout the text of this specification. Each of the documents herein (including any manufacturer's specifications, instructions etc.) are hereby incorporated by reference; however, there is no admission that any document cited is indeed prior art of the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it doe not exclude other elements or steps. It is thus to be interpreted as specifying the presence of the stated features, integers, steps or components as referred to, but doe not preclude the presence or addition of one or more other features, integers, steps or components, or groups thereof. Thus, the scope of the expression “a device comprising means A and B” should not be limited to the devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, the term “methylation profile” refers to a set of data representing the methylation states of one or more loci within a molecule of DNA from e.g., the genome of an individual or cells or tissues from an individual. The profile can indicate the methylation state of every base in an individual, can have information regarding a subset of the base pairs (e.g., the methylation state of specific promoters or quantity of promoters) in a genome, or can have information regarding regional methylation density of each locus.

As used herein, the term “methylation status” refers to the presence, absence and/or quantity of methylation at a nucleotide or nucleotides within a portion of DNA. The methylation status of a particular DNA sequence can indicate the methylation state of every base in the sequence or can indicate the methylation state of a subset of the base pairs (e.g., whether the base is cytosine or 5-methylcytosine) within the sequence. Methylation status can also indicate information regarding regional methylation density within the sequence without specifying the exact location.

As used herein, the term “ligation” refers to any process of forming phosphodiester bonds between two or more polynucleotides, such as those comprising double stranded DNAs.

Techniques and protocols for ligation may be found in standard laboratory manuals and references. Sambrook et al., In: Molecular Cloning. A Laboratory Manual 2nd Ed.; Cold Spring Harbor Laboratory Press, Cold Spring Harbor, N.Y. (1989) and Maniatis et al., pg. 146.

As used herein, the term “probe” refers to any nucleic acid or oligonucleotide that forms a hybrid structure with a sequence of interest in a target gene region (or sequence) due to complementarity of at least one sequence in the probe with a sequence in the target region.

As used herein, the terms “nucleic acid,” “polynucleotide” and “oligonucleotide” refer to nucleic acid regions, nucleic acid segments, primers, probes, amplicons and oligomer fragments. The terms are not limited by length and are generic to linear polymers of polydeoxyribonucleotides (containing 2-deoxy-D-ribose), polyribonucleotides (containing D-ribose), and any other N-glycoside of a purine or pyrimidine base, or modified purine or pyrimidine bases. These terms include double- and single-stranded DNA, as well as double- and single-stranded RNA. A nucleic acid, polynucleotide or oligonucleotide can comprise, for example, phosphodiester linkages or modified linkages including, but not limited to phosphotriester, phosphoramidate, siloxane, carbonate, carboxymethylester, acetamidate, carbamate, thioether, bridged phosphoramidate, bridged methylene phosphonate, phosphorothioate, methylphosphonate, phosphorodithioate, bridged phosphorothioate or sulfone linkages, and combinations of such linkages.

As used herein, the term “CpG Island”, refers to any DNA region wherein the GC composition is over 50% in a “nucleic acid window” having a minimum length of 200 bp nucleotides and a CpG content higher than 0.6.

As used herein, the term “promoter”, refers to a sequence of nucleotides that resides on the 5′ end of a gene's open reading frame. Promoters generally comprise nucleic acid sequences which bind with proteins such as, but not limited to, RNA polymerase and various histones.

The phenomenon of photobleaching (also commonly referred to as fading) occurs when a fluorophore permanently loses the ability to fluoresce due to photon-induced chemical damage and covalent modification. Upon transition from an excited singlet state to the excited triplet state, fluorophores may interact with another molecule to produce irreversible covalent modifications. The triplet state is relatively long-lived with respect to the singlet state, thus allowing excited molecules a much longer timeframe to undergo chemical reactions with components in the environment. The average number of excitation and emission cycles that occur for a particular fluorophore before photobleaching is dependent upon the molecular structure and the local environment. Some fluorophores bleach quickly after emitting only a few photons, while others that are more robust can undergo thousands or millions of cycles before bleaching.

The DNA sequencing of individual genomes is rapidly becoming a reality. Recent developments in single molecule sequencing allow the analysis of an individual genome in a timeframe of around one week. Such methods employ massively parallel DNA sequencing strategies, which sequence short regions of the genome, from 30² up to 1500³ bases in length and follow this with the assembly of the genome from these fragments. In principle, the approach is a simple and incredibly effective one, yet it has one significant flaw and this occurs where the DNA sequence repeats with a length that is greater than the size of the sequenced fragments. In such a case the linear assembly of the genome can become ambiguous.

Such duplications of sequence are surprisingly common. Known as copy number variations (CNVs), these repeats of the DNA sequence, measured relative to a reference genome⁴, are of greater than 1 kilobase in length⁵ and can reach lengths of several megabases. On a study of the genomes of 270 individuals, copy number variable regions were found to cover a total of 360 megabases, or approximately 12% of the human genome⁵. They have been implicated in a variety of genetic disorders including schizophrenia⁶ and congenital heart defects⁷. Repeats can be detected using third-generation sequencing methods¹ but these techniques represent a rather labor and material-intensive route to studying CNVs. Further, given the variable number of copies that may be present and the hugely variable length of these repeats, the suitability of parallel sequencing methods for studying copy number variations is debatable.

Optical mapping of DNA is a complementary technique to DNA sequencing and in principle it provides a simple and intuitive route to visualize the sequence of a DNA molecule, typically on the scale of kilo- to mega-bases. Such mapping is critical to validate the assembly of short DNA sequence reads, particularly in complex and repetitive genomes⁸. Optical mapping utilizes molecular combing⁹ in order to linearly align large DNA molecules on a surface, allowing for their subsequent imaging and the linear positioning of, for example, restriction enzyme sites along the DNA. Optical mapping using restriction enzymes, has been pioneered by the Schwartz lab^{10,11} and the technique has been critical in validating the final versions of many genomes¹²⁻¹⁴. Typically, it utilizes restriction enzymes that recognize 6- or 8-base sequences, giving a cleavage site on average every ˜4 kilobases or ˜65 kilobases, respectively (though these figures vary significantly depending on the genome).

‘DNA bar codes’ offer an alternative strategy to optical restriction mapping that also yields a genomic-scale map of the DNA sequence. These methods use sequence-specific fluorescent labeling of DNA and have the potential to be combined with sub-diffraction limit imaging techniques to significantly improve on the resolution that results from restriction mapping. Yet no study has been able to successfully achieve both the sequence-specificity of restriction mapping and sub-diffraction limit positioning of fluorescent probes. Gad et al¹⁵ have reported a DNA ‘bar codes’ for the BRCA1 and BRCA2 genes, variations in which are known to increase susceptibility to breast cancer. Using fluorescent antibodies the detection of a large deletion (˜24 kb) in the BRCA1 gene at the single molecule level is readily achieved. DNA mapping with sub-diffraction-limit positioning of fluorophores has previously been carried out by Qu et al¹⁶ who used 7-base-long bis-PNA molecules that bind sequence-specifically to DNA to provide an optical map of a single lambda DNA molecule. However, the binding of the bis-PNA molecules was, in fact, found to be rather non-specific. An exciting possibility for the DNA bar code is its potential to be used in a high-throughput format, as has previously been demonstrated by Jo et al¹⁷. They developed a method for mapping DNA molecules as they are driven through ‘nanoslits’ by an electric potential. In this approach, nick translation was used to label the DNA and fluorophore positions were determined with a standard deviation of around 3.5 kb. Nick-translation has also been employed in combination with molecular combing to produce DNA barcodes using standard optical microscopy¹⁸.

We report a significant advance on the current state-of-the-art in optical DNA mapping by using a DNA methyltransferase to label the DNA at sequences reading 5′-GCGC-3′. The unique and reproducible pattern produced by this labeling, in combination with the high labeling density and sub-diffraction-limit localization of the fluorophores, enables identification of elements of the DNA at the level of single genes.

A methods of obtaining structural information about a biopolymer sample such as DNA or RNA, and preferably a DNA, whereby the method involves labelling a portion of the biopolymer using a methyltransferase and a modified methyltransferase cofactor which is a synthetically prepared cofactor, for instance Ado-11-amino, whose chemical structure is shown in FIG. 1, was used in the present invention. Normally, labeling can be carried out using similar modified cofactors to Ado-11-amino as described in WO2006108678 A2 (New s-adenosyl-1-methionine analogs with extended activated groups for transfer by methyltransferases) or, in an alternative embodiment, by using modified cofactors as described by WO 0006587 A1 (New cofactors for methyltransferases) and in references 19, and 21 of this application. In an alternative embodiment, labelling could be achieved using a combination of the adenosyl-moeity, whose preparation is described by Ottink et al³³ and the transferable groups described in WO2006108678 A2, which is highlighted for Ado-11-amino, in FIG. 1.

This labelling of DNA can be after linearizing the biopolymer in some cases for instance by stretching it onto a surface. For instance the DNA molecules are labeled at HhaI sites with Atto647N and are stretched onto a PMMA-coated surface using an evaporating droplet. For instance present invention using a DNA methyltransferase enzyme, for instance such methyltransferase enzyme, such as M.HhaI DNA methyltransferase, such as M.HhaI DNA methyltransferase, that recognizes the four-base sequence ′5′-GCGC-3′ and targets the underlined cytosine for modification at the C5-position to direct the fluorescent labeling of genomic DNA, and some synthetically prepared cofactors DNA, such as Ado-11-amino, is sequence-specifically labeled by a fluorophore at sequences reading 5′-GCGC-3′. This results in a unique and reproducible pattern produced by this labeling, in combination with the high labeling density and sub-diffraction-limit localization of the fluorophore, such as xanthene dye, Atto647N or 647N NHS, enabling identification of elements of the DNA at the level of single genes.

In a particular embodiment DNA molecules labeled at HhaI sites with Atto647N are stretched onto a PMMA-coated surface using an evaporating droplet. The advantage is the reproducibility stretching using small μl or less volumes to form the droplet. For instance 1 μL of solution containing ˜10 pM Atto647N-labeled DNA molecules can as single and linearly stretched molecules be deposited onto a PMMA-coated coverslip. The droplet is left uncovered and allowed to evaporate. The stretching of single DNA molecules can readily be visualized on the microscope

The use of the methyltransferase is non-destructive and allows the targeting of the fluorescent labels to short DNA sequences of only four bases in length. Hence, on average we can position one fluorophore every 256 bases and even, we can resolve a distance between fluorophores of just 20 bases. Such high resolution is particularly possible thanks to the unique combination of the labelling method and the analysis software that we developed. Our analytical approach allows the reconstruction of the DNA molecule and its display as a ‘fluorocode’; an optical map with unprecedented resolution. This improvement in resolution and fluorophore coverage of the DNA is significant since it enables the study of DNA sequence on the scale of the genome and at the single molecule level for the first time. Potential applications include DNA profiling for forensic science, genome assembly, the study of copy number variations, of the methylation status and of heritable diseases.

The present invention can be used for more accurate methylation detection in a DNA sample that has been fragmenting a nucleic acid sample, ligated with adaptors to the ends of the nucleic fragments obtained, whereof fragments have been amplified that include both adaptors using specific primers based on the adaptors, whereof the amplified fragments have been labeled according to the above and the methylation state of the sample has been determined. Methodological strategies for analyzing the methylation state of CpG islands have been constantly evolving. Most of the methods are based on the chemical conversion of unmethylated cytosines to uracils by treating them with sodium bisulfite, which does not affect the 5-methylcytosines and individually and reliably identifies the CpG dinucleotides as being either methylated or unmethylated. DNA modification, its amplification by polymerase chain reaction (PCR), and/or automated sequencing are the most commonly used techniques in this context (Esteller M. Aberrant DNA methylation as a cancer-inducing mechanism. Annu Rev Pharmacol Toxicol. 2005; 45:629-56). In recent years the technology based on analysis of methylated DNA has come to be regarded as a powerful tool for the diagnosis, treatment, and prognosis of disease, as well as in the fields of forensic medicine, pharmacogenetics, and epidemiological studies. The association between the hypomethylated state of DNA and cancer, and later, its relationship with hypermethylation, have been known about since 1983; however, in the past five years, under the impetus of the new molecular strategies for studying de novo methylation of CpG islands, the analysis of methylated DNA has become a powerful biomarker for the early detection of cancer; in addition, it allows cancers to be classified according to histological subtypes, the degree of malignancy, differences in treatment response, and the various prognoses. An important recent application is precisely its use as a biomonitor of treatment response and a predictor of the prognosis in cancer. The present invention can thus comprise method of nucleic acid analysis comprising the following stages: a) fragmentation of a genomic DNA sample, b) ligation of specific adaptors to the ends of the DNA fragments obtained, where one of the specific adaptors comprises a functional promoter sequence, c) amplification of the fragments that include both adaptors using specific primers based on the adaptors, d) labeling of the amplified DNA fragments by using a DNA methyltransferase and a modified methyltransferase cofactor which is a synthetically prepared cofactor, for instance Ado-11-amino, and e) determining the methylation state of the sample.

DNA methylation is an epigenetic process that is involved in regulating gene expression in two ways: directly, by preventing transcription factors from binding, and indirectly, by favoring the “closed” structure of chromatin (Singal R, & Ginder GD. DNA methylation. Blood. 1999 Jun. 15; 93(12):4059-70). DNA has regions of 1000-1500 bp rich in CpG dinucleotides (CpG islands), which are recognized by the DNA methyltransferases which, during DNA replication, methylate the carbon-5 position of cytosines in the recently synthesized string, so that the memory of the methylated state is preserved in the daughter DNA molecule. Methylation is generally considered to be a one-way process, so that when a CpG sequence is methylated de novo, this change becomes stable and is inherited as a clonal methylation pattern. Moreover, the change in the methylation state of regulatory genes (hypomethylation or hypermethylation), being a primary event, is frequently associated with the neoplastic process and is proportional to the severity of the disease (Paluszczak J, & Baer-Dubowska W. Epigenetic diagnostics of cancer—the application of DNA methylation markers. J Appl Genet. 2006; 47(4):365-75). The genomes of preneoplastic, cancerous, and aging cells share three important changes in methylation levels, marking them out as early events in the development of certain tumors. Firstly, hypomethylation of heterochromatin, leading to genomic instability and an increase in mitotic recombination events; secondly, hypermethylation of individual genes, and lastly, hypermethylation of the CpG islands of constitutive and tumor suppressor genes. The two methylation levels can occur separately or simultaneously; generally speaking, hypermethylation is involved in gene silencing and hypomethylation is involved in the overexpression of certain proteins implicated in the processes of invasion and metastasis.

DNA methylation is an epigenetic marker of gene silencing with applications in various fields of genetic and biomedical research which, through the application of molecular methodological processes, allows individual CpG island methylation patterns to be differentiated. Moreover, the methylation characteristics of the genes involved in neoplasia allow cancers to be classified and prognosed, and treatment to be followed up.

### EXAMPLES

We present a method to produce what we term a DNA fluorocode (since we find the use of ‘DNA barcode’ rather conflicts with the more common, taxonomic use of this term); a DNA profile derived from the observation of one or more DNA molecules that are sequence-specifically labeled, and stretched onto a polymer-coated surface.

### Methods

### Example 1

### DNA Labeling Using Methyltransferase-Directed Transfer of Activated Groups (mTAG)

20 μg of X DNA (Fermentas) was incubated with M.HhaI (variant Q82A/Y254S/N304A) (equimolar amount to the target sites) and 20 M synthetic cofactor Ado-11-amino in 4001 of M.HhaI buffer (50 mM Tris.HCl pH 7.4, 15 mM NaCl, 0.01% 2-mercaptoethanol, 0.5 mM EDTA, 0.2 mg/ml BSA) for 30 min at 37° C. The completion of the modification reaction was verified by treating a 101 aliquot with R.Hin6I (Fermentas) and agarose gel electrophoresis. The modified DNA was then incubated with 187 g of Proteinase K (Fermentas) in the M.HhaI buffer supplemented with 0.025% SDS for 1 hour at 55° C. DNA was purified by passing through a 1.6 ml Sephacryl™ S-400 column in PBS buffer followed by isopropanol precipitation. Pellet was dissolved in 0.15 M NaHCO₃ (pH 8.3) and incubated with a 75-fold molar access of ATTO-647N NHS ester (ATTO-TEC) for 6 h at room temperature. Fluorophore-labeled DNA was purified and redissolved in water as described above.

### Example 2

### Coverslip Preparation

Coverslips were mounted in a Teflon rack and then washed by sonication in acetone, then 1M NaOH, followed by MilliQ-water (×2). Each sonication was carried out for 15 minutes. Polymethylmethacrylate (PMMA) (0.1% wt/vol) in chloroform was spin-coated (2000 rpm) onto the cleaned coverslips. The PMMA was subsequently annealed to the coverslips by baking at 120° C. for 1 h.

### Example 3

### DNA Combing

Droplets of 1 uL volume, containing approximately 0.2 ug/ml of the labeled lambda DNA in 50 mM MES buffer at pH5.7 were deposited onto the PMMA-coated coverslips. The coverslips were placed on a heat block at 60° C. and droplets allowed to evaporate for 30 min.

### Example 4

### Fluorescence Microscopy

Movies of photobleaching, labeled DNA molecules were recorded using an Olympus IX71 microscope coupled to a Hammamatsu Image-EM C9100-13 CCD camera. The microscope setup has been described in detail previously³². A Spectra Physics 635C-60 diode laser (635 nm) was used as an excitation source and fluorescence emission from the sample was detected via a Chroma Q660LP Dichroic filter and an HQ700/75m emission bandpass filter.

Exposure time and laser intensity varied from sample to sample but were set such that the photobleaching of all of the fluorophores on a single DNA molecule required around 1000 frames of movie (typically 2-3 minutes).

### Example 5

### Sub-Diffraction-Limit Positioning of Fluorophores

We developed a program to fit the position of each of the fluorophores along a DNA molecule with sub-diffraction-limit precision making use of the fact that the emission for different fluorophores is additive. Whilst it is very difficult to localize several emitters when their emission profiles lie within an area whose dimensions that are sub-diffraction limit (˜250 nm), the stochastic nature of photobleaching means that any such group of emitters inevitably photobleaches until only one remains. The emission that we observe (a diffraction-limited spot) from this last fluorophore can be modeled and fitted using a two-dimensional Gaussian profile. By subtracting this emission from all previous frames in the movie, the emission of the penultimate emitter can be resolved. By applying this strategy recursively, in principle, the contribution of every emitter in the movie can be extracted. However, this strategy is prone to failure if the more than one emitter within a diffraction-limited spot bleaches simultaneously or if the emitters display complex fluorescence dynamics, such as ‘photoblinking.’ In the system measured here the linear distribution of the fluorophores means that we can predict a maximum of eight emitters can lay within a diffraction-limited region. Hence, simultaneous bleaching of more than one fluorophore in such a region is rare.

While some blinking was indeed observed, we minimized its effect through longer integration times (200-500 milliseconds) and by binning adjacent frames of the movie before running the bleaching analysis. Typically, the complete bleaching of the emitters yielded movies of 1000 frames in duration.

### Example 6

### Visualization and Alignment of the DNA Fluorocodes

Fluorophore positions were visualized, creating the fluorocodes, for individual DNA molecules using a Matlab routine which convolves a Gaussian point spread function with the projected position of each of the fluorophores on a line. In order to align a fluorocode from an individual molecule (data) to another fluorocode an intensity profile along each fluorocode is generated using a PSF for each fluorophore of 80 nm. The two intensity profiles are aligned by laterally shifting and stretching the reference profile to fit the profile of the data. The stretching factor applied to the reference map is allowed to vary between 1.2 and 2.0 and this and the lateral shift parameter are optimized by maximizing the output from the convolution of the two. The Matlab code is available on request.

### Example 7

### Sequence-Specific Fluorescent Labeling of DNA

In order to generate sequence-specifically labeled DNA, with an exceptionally high labeling density, we employed the ‘methyltransferase-directed transfer of activated groups’ (mTAG) method^{19,20}. The reaction results in a covalent modification of DNA at target locations determined by the specificity of the DNA methyltransferase enzyme. The density of labeling is tunable, depending on the methyltransferase enzyme used to carry out the mTAG reaction, but can far exceed that achievable using either nick-translation, PCR-based methods or non-covalent methods of sequence-specific labeling, such as triple helix formation.

Fluorescent labeling using mTAG is a simple two-step procedure. The first step is a DNA methyltransferase-catalyzed covalent attachment of a linear side chain with a terminal amino group to the DNA. This reaction occurs upon incubation of the DNA along with a DNA methyltransferase and a modified methyltransferase cofactor, which is synthetically prepared²¹. We employed an engineered version of the HhaI DNA methyltransferase enzyme (M.HhaI) of Lapinaite, Lukinavicius, which recognizes the four-base sequence ′5′-GCGC-3′ and targets the underlined cytosine for modification at the C5-position to direct the fluorescent labeling of genomic DNA from the lambda bacteriophage. DNA methyltransferases, which typically work with these modified cofactors as wild-type enzymes or sterically engineered variants^{19,20}, offer a broad range of recognition site specificities²² and, hence, sequence coverage can be tailored to suit the DNA molecule and problem of interest¹⁹. The resulting ‘derivatized DNA’ can be fluorescently labeled by incubation with a standard, commercially available amine-reactive fluorophore (succinimidyl ester). For this, we used the xanthene dye, Atto647N.

There are a total of 215 target sites for HhaI on the 48.5 kbases of the lambda phage genome, which have a distinctive distribution along the molecule, as indicated in FIG. 2. 149 HhaI sites lie between base 1 and 22500, a ˜5000 base gap defines the central region of the lambda DNA molecule and a less densely labeled region, from 27500 bases to the end of the molecule contains the remaining 66 HhaI sites. FIG. 1 depicts a fluorocode generated for a lambda molecule that is uniformly stretched, where the position of each fluorophore in the image has a generated (Gaussian) point-spread function (PSF) with a full-width half maximum of 305 nm and where the DNA has been labeled at every HhaI site on the molecule.

### Example 8

### Combing the Labeled DNA

Lambda DNA molecules labeled at HhaI sites with Atto647N, were stretched onto a PMMA-coated surface using an evaporating droplet²³⁻²⁵. This method gives reproducible stretching using small sample volumes. To form the droplet, we use 1 μL of solution containing ˜10 pM Atto647N-labeled lambda DNA and deposit this onto a PMMA-coated coverslip. The droplet is left uncovered and allowed to evaporate. The stretching of single DNA molecules was readily visualized on the microscope, as shown in FIG. 3. We favored the use of the PMMA-coated surface for these experiments, since the great majority of the DNA molecules are deposited as single and linearly stretched molecules on this surface. Similar experiments on a silanized surface resulted in the deposition of DNA aggregates and molecules with complex topologies (data not shown), relative to those deposited on PMMA.

### Example 9

### Visualization and Localization of Fluorophores

The DNA molecules were visualized using a standard wide-field fluorescence microscope, coupled to a Hamamatsu Image-EM C9100-13 CCD camera. In order to determine the position of each of the fluorophores along the DNA molecule we fit a 2-dimensional Gaussian profile to the observed diffraction-limited spots in the experimental data^{26,27}. This enables us to localize any given fluorophore with sub-diffraction-limit precision. Indeed, we found that, by manually fitting of the position of a single fluorophore over 20 subsequent frames of a movie the distribution of localized positions has a standard deviation of just 9.1 nm (this equates to 16.9 base pairs, where the step between pairs is 5.38 Å due to the overstretching of the DNA). Hence, a measurement between two localized fluorophores is possible, in principle, with a standard deviation of just 12.9 nm (simply derived from the square root of the sum of the squares of the error in fitting an individual fluorophore).

Such high experimental resolution, combined with our sequence-specific labeling reveals heterogeneity in the stretching of the DNA molecules (FIG. 6) and deviations in the path described by the DNA molecules on the PMMA surface (FIG. 4). This has important consequences for our measurements, since we ultimately want to know to which base a given fluorophore is attached. In fact, the error in determining the labeling site on the DNA is significantly greater than the error in fitting its absolute position in the field of view. In order to estimate the error in our measurements along the DNA molecule we measured the observed gap between the fluorophores at the centre of the 20 DNA molecules shown in FIG. 6. Here, we find a standard deviation in the measurement of this ˜5000 base gap of 190 bases. Assuming an equal contribution to this error from the positions of each of the two fluorophores used in the measurement, then we find that the standard deviation in determining the position of an individual fluorophore on the DNA duplex is 135 bases, or 72 nm. This level of precision is unprecedented in any optical mapping study and, as we will show, allows the unambiguous alignment of single DNA molecules to a reference sequence.

In the context of the densely labeled DNA molecule, sub-diffraction-limit localization of a fluorophore necessitates the isolation and identification of the emission from individual fluorophores on the DNA. One established approach to enable this is the dSTORM²⁸-30 technique, which utilizes on/off switching in organic fluorophores to ensure that single emitters can be readily isolated and their positions accurately determined. Whilst our labeling approach allows the use of this technique in principle, in practice we found that the DNA immediately dissociated from the surface upon addition of a solution (used to enable the on/off switching in dSTORM experiments) to the sample. Hence, we used an approach which utilizes the single-step photobleaching of individual fluorophores as a means to identify and localize them^{16,31}. This approach enables the use of a wide range of fluorophores for these experiments and does not require the use of an imaging buffer. Movies of the photobleaching of the labels on single DNA molecules were recorded, typically using a relatively long exposure time (i.e. 0.3 s) and low excitation power in order to minimize the effect of fluorophore blinking on our analysis. FIG. 4 shows the result of one such analysis.

### Example 10

### Construction of the Fluorocode

Following localization of each of the fluorophores on a DNA molecule, a line is projected along the molecule and the distance of each fluorophore along this line is determined. The DNA fluorocode is generated by displaying the fitted points along this line as an image where each fluorophore position (point) is described using a Gaussian point spread function (PSF) with a full-width at half maximum height (FWHM) of our choosing. In order to reconstruct the fluorocode for comparison against the raw data, we use a PSF of 305 nm (typical of the PSF for a dye emitting at 700 nm). We reduce this to 80 nm (150 base pairs (approximately one standard deviation in our measurement along the DNA molecule)) in order to compare fluorocodes with one another.

20 individual DNA molecules were analyzed in this way. Molecules were selected for analysis where the labeling was sufficient that it was clear that the DNA molecule was approximately full length and where the DNA-strand was not obviously composed of more than one molecule. FIG. 5 shows the generated fluorocode for one such molecule, along with the first image from the movie and an image based on the average intensity of the emission over the entire movie.

FIG. 6 shows the similarly generated fluorocodes for 20 single lambda DNA molecules. The number of localized fluorophores on a single DNA molecule varies between 64 and 109 with a mean of 85 fluorophores. Of these, we are able to assign positions (to the closest labeling site on a reference map) for an average of 66 fluorophores with a standard deviation of 96 bases between the fitted positions and those on the reference map. By comparison, optical restriction mapping typically results in one cut to the DNA every 20 kilobases¹² (though fragments as small as 700 bases can be characterized) and so one might expect to observe just three or four cut-sites on the lambda DNA molecule¹¹. Hence, at the single molecule level, we observe an unprecedented density of sequence-specific labeling that enables the DNA to be readily oriented and aligned with another molecule by eye and for the identification and characterization of regions of the molecules of the order of several kilobases in size (FIG. 6B). The fluorocode potentially enables the first, truly single molecule analysis of genomic DNA sequences at kilobase resolution.

In order to increase the number of localized fluorophores in the fluorocode and to remove some of the inhomogeneities (for example, non-specific labeling and breaks of the DNA during stretching) that result from examining single molecules we designed a program to stretch and offset localized fluorophore positions to align them relative to a reference sequence. The program generates intensity profiles of the reference sequence and experimentally derived fluorophore positions and then uses a simple convolution of the two profiles, maximizing their overlap, in order to determine the best fit of the data to the reference sequence. Using this program and the map of HhaI sites on lambda DNA as a reference sequence, we were able to create a consensus fluorocode that is remarkably similar to the reference map of HhaI sites, down to the level of the individual fluorophore, as shown in FIG. 6.

The consensus fluorocode shown in FIG. 6 contains 308 localized fluorophores. We can associate 177 of these positions with HhaI sites on the lambda molecule with a standard deviation between the experimentally derived and reference positions of 50 bases. Raising the threshold of the fit such that three counts are necessary within a bin before a point is added to the consensus fluorocode gives 63 fluorophore positions, all of which can be associated to known HhaI sites on the DNA with a standard deviation of 50 bases between the experimentally derived and expected positions of the fluorophores.

Away from the ends of the molecule the reference map and the consensus fluorocode are remarkably coincident. Indeed, the relative intensities of the peaks in the fluorocode faithfully represent the expected number of fluorophores in a given region of the reference map. We believe that the fluorophores at either end of the DNA molecule are underrepresented in the experimental data because of breakage of the DNA molecules during the labeling and combing processes. The apparent bias in the consensus map results from our selection of only the longest DNA molecules (missing short fragments from their ends) for analysis.

One of the great advantages of the fluorocoding method is its potential to be used independently of a reference sequence. We selected the DNA molecule with the most fitted positions from the experimental data and aligned the fluorocodes of the other molecules to it.

In this instance, a consensus fluorocode was generated using a total of fourteen molecules.

Alignment of the experimentally derived consensus to the reference map is readily achievable and reliable localization of individual fluorophores is possible. When compared to the reference sequence, we were able to assign 98 of the 215 fluorophores with a standard deviation between the fitted positions and reference positions of 90 bases. Hence, the fluorocode offers a potential route to studying copy number variations in the absence of a reference sequence.

### Example 11

### Fluorocode Software

The software describes a way to construct a DNA fluorcode from a time-lapse movie recording the fluorescence emission of a sequence-specifically labeled DNA molecule in time. These movies are recorded by placing the sample on a fluorescence microscope and imaging the resulting fluorescence in time, in such a way that one or more labeled molecules are visible within the field of view. The movie recording starts when the sample is initially exposed and continues until the fluorescence emission has disappeared due to photodegradation. The processing requires that the DNA molecules remain immobile with respect to the imaging equipment for the entire duration of the measurement.

A fluorocode requires the estimation of the location of all N emitters in a particular DNA molecule. The developed software achieves this by making use of the stochastic nature of single-fluorophore photodegradation: to a very good approximation each fluorophore in the sample will undergo photodestruction independently from all the other emitters, which will cause its fluorescence contribution to disappear. The ‘digital’ nature of this event is well-known in single-molecule spectroscopy, and allows the occurrence of the bleaching event to be observed clearly. The concept as such can be applied to any technique in which the fluorescence is rendered undetectable over the course of the imaging, including changes in excitation efficiency, emissivity, or absorption/detection spectra.

To a very good approximation the observed fluorescence at any instant in time is independent for every fluorophore. This means that the observed fluorescence image, at any instant, is simply the sum of the fluorescence contribution of every fluorophore. Here the contribution means the recorded emission of every fluorophore per acquisition frame, including knowledge of the position and shape of this emission distribution, as determined by the characteristics of the fluorophore and the imaging system. It follows then that, if the sample contains N emitters, and the contribution of N−1 emitters is known, the contribution from the Nth emitter can be trivially estimated through subtraction of the known contributions from the recorded image.

The developed software uses this concept by executing its analysis in reversed order: starting from the last frame of the acquired data, the software progressively works its way towards the beginning of the data, looking for the first frame in which an emitter can be discovered. This particular emitter will correspond to the fluorophore that was the last to disappear, and therefore its contribution can be estimated exactly, using knowledge on the properties of the used imaging system. The contribution of the emitter is estimated and stored into memory.

The software now subtracts the contribution of this Nth emitter from all preceding frames (in which is was still active), allowing the discovery and estimation of the (N−1)th emitter, which is then in turn estimated and subtracted. By iteratively applying this procedure over the entire length of the movie, the contribution of every emitter can be estimated.

Schematically the analysis can be presented as follows:

1. Get the previous frame recorded in the measurement, starting from the end of the movie.

2. Subtract the contributions of emitters that have already discovered.

4. Subject the resulting modified image to a routine that discovers the contribution of newly-appeared emitters

5. Estimate the contributions of these emitters and store these in computer memory.

The DNA fluorocode is constructed by taking the points that are the localizations for the individual fluorophores identified in the fitting process and translating the distances between these points into a distance in base pairs along a DNA molecule. The extent and uniformity of the stretching of each individual DNA molecule can vary as a result of the deposition and linearization steps of the procedure. DNA molecules can also break during handling and deposition. These physical variations have to be accounted for in our analytical treatment of the data. Hence, we wrote a software program to stretch and align the localized fluorophores from two or more DNA molecules.

This software creates an image displaying the localized single emitters along a DNA molecule with a point-spread function that is defined by the user. Then, an intensity profile along the longitudinal axis of the image of the DNA molecule is taken. This intensity profile is compared with a similarly derived profile from a second DNA molecule, which may or may not be a reference molecule of known DNA sequence. The profiles are superimposed and their overlap is calculated using their convolution for a series of different stretching ratios (of one molecule relative to the other). The product of the convolution, F(k), at each stretching ratio is defined by

$$F ( k ) = x ( k ) ⊗ y ( k ) = {\sum }_{j = - ∞}^{∞} x ( j ) y ( k - j )$$

where x(k) and y(k) describe the intensity profiles of the data and reference DNA molecules, respectively. When molecule x has a length r and molecule y has a length s, the convolution (for all non-zero values) has a length of r+s−1, where r and s are written in terms of the number data points used to describe the intensity profiles x(k) and y(k).

As a result, the software builds up a two-dimensional landscape from which it can choose the optimal combination of stretch and shift values within the ranges defined by the user. The program output is a series of points along a line which describes the determined position in base pairs of each of the labels on the DNA molecule and an image, the DNA fluorocode, which depicts this molecule.

### DISCUSSION

DNA fluorocoding potentially enables true single-molecule DNA profiling thanks to a combination of sequence-specificity, fluorophore coverage of the DNA and diffraction-unlimited resolution in the determination of fluorophore positions that restriction mapping and other previously reported methods for creating DNA bar codes cannot approach. For an individual DNA molecule, on average, we are able to position 30% (66 of 215 fluorophores) of the target sites for HhaI with a standard deviation of just 100 bases. In other words, on average, we are able to localize one fluorophore every 735 bases and the maximum resolution of our experiment is determined only by our optical resolution, which is as low as 10 nm, or just 18 bases. Hence, we expect the fluorocode to enable the first single-molecule studies of copy number variations, where the sequence repeats are of the order of several kilobases in size.

We have shown that we can significantly improve sequence coverage by combining data from several DNA molecules to generate a consensus fluorocode. Indeed, 82% of the target sites for HhaI are described in our consensus fluorocode (FIG. 6B), constructed from 20 DNA molecules. If we consider the lack of experimental data describing the ends of the DNA molecules, then, in fact we see 92% of the sites (160 of 173) between positions 5630 and 45681 on the lambda molecule assigned in the consensus fluorocode. On average this equates to one fluorophore every 250 bases. The standard deviation in the position of the fluorophores assigned to each of these sites is just 50 bases. Hence, the consensus fluorocode enables the construction of an optical map of genomic material with unrivalled detail and the unambiguous study of DNA motifs on the scale of the single gene.

A fundamental advantage of both optical restriction mapping and the fluorocode over other methods of optical mapping is their lack of necessity for a priori targeting of specific DNA sequences

(as in PCR- or antibody-based labeling approaches). This enables an holistic approach to genome analysis and, in theory, makes mapping the genome possible in a single experiment and without any prior knowledge of the DNA sequence. Indeed, as we show in FIGS. 5 and 6, the fluorocode enables the study of the DNA sequence in the complete absence of a reference map permitting entirely independent detection of repeat sequences of DNA, such as copy number variations.

Using a fluorescent labeling approach to map genomic DNA has distinct advantages over optical mapping using restriction enzymes. We have shown that these include the use of a far higher density of targeted (labeled) sites on the DNA and improved precision in determining the location of these sites. Yet there are significant advances still to be made using the fluorocoding approach. For example, multi-color labeling of the DNA using two or more methyltransferases to direct the labeling will create a color fluorocode that allows a high degree of confidence in the analysis and interpretation of the fluorocode. Such an approach would also enable the optical readout of a DNA molecule flowing through a nanoslit, such as those designed by Jo et al¹⁷. In all, the fluorocode offers a novel and versatile route to optically map genomic DNA in unprecedented detail.

Other embodiments of the invention will be apparent to those skilled in the art from consideration of the specification and practice of the invention disclosed herein.

It is intended that the specification and examples be considered as exemplary only.

Each and every claim is incorporated into the specification as an embodiment of the present invention. Thus, the claims are part of the description and are a further description and are in addition to the preferred embodiments of the present invention.

Each of the claims set out a particular embodiment of the invention.

The following terms are provided solely to aid in the understanding of the invention.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 shows a reaction scheme showing (top) the DNA methylation reaction and (bottom) the methyltransferase-directed transfer of activated groups.

FIG. 2 is a generated image of an ideal fluorocode for lambda phage DNA. Each fluorophore position is displayed with a (Gaussian) point spread function that has a full-width half maximum (FWHM) of 305 nm, the expected size of a diffraction-limited spot for a single molecule emitting at 700 nm. The molecule is shown with a step between base pairs of 3.4 Å and has a length of 16.5 μm. Also shown is the map of the known HhaI sites on the lambda DNA molecule which are used to construct the fluorocode. Vertical ticks indicate the position of the HhaI sites.

FIG. 3 displays DNA combing using an evaporating droplet. Stills taken from a movie of. Exposure time is and each frame is 41.5 μm in size. DNA molecules that are adsorbed to the surface in the early frames of the movie are swept away by the receding edge of the droplet. Deposition occurs at the air-water interface, which is clearly seen in the movie because of the bright but blurred fluorescence intensity from several DNA molecules that are rapidly diffusing there. DNA molecules are combed and stretched to around 1.6× their crystallographic length.

FIG. 4 shows fluorophore localization using photobleaching to identify individual emitters. Here, movie frames are shown in reverse chronological order, just as in our analytical procedure. Frames 1-4 show the observed intensity changes as two spatially close emitters are switched ‘on’ (there are many frames between 2 and 3). Frames A-D show emitters switching ‘on’ and, in the next frame and following localization of the emitter, their signal being subtracted from the remainder of the movie. The positions of the localized chromophores are indicated by the crosses in frames 2-4.

FIG. 5 are images that displays the comparison of the fluorocode to the raw data. A) Image taken from the first frame from the recorded photobleaching movie. B) An average image from all of the frames of the movie and (C) The DNA fluorocode, where each localized fluorophore is shown with a PSF with a FWHM of 305 nm.

FIG. 6 A) Automatically generated alignments of fluorocodes recorded for twenty lambda DNA molecules. Positions have been determined and all localized fluorophores are displayed with a 42 nm PSF. Each molecule is stretched 5-fold perpendicular to the DNA axis in order to enable simple inspection and intuitive alignment of the fluorocode. B) Top: The consensus fluorocode derived from the experimental data where more than three counts are required in a given 33-base bin before that bin is added to the consensus. Middle: The consensus fluorocode derived from the experimental data where more than two counts are required in a given 33-base bin before that bin is added to the consensus. Bottom: The fluorocode derived from the reference ‘HhaI map’ to which all of the experimental data is aligned.

FIG. 7—The output of the programme designed to stretch and offset experimental data with respect to a reference map. The result of the convolution of the intensity profiles from the fluorocodes of the map of HhaI sites on lambda DNA (grey) and data from a single molecule of HhaI-labelled lambda DNA (black) is maximised in order to determine the best stretch and offset parameters. Also shown is the map of the known HhaI sites on the lambda DNA molecule which are used to construct the reference fluorocode. Vertical ticks indicate the position of the HhaI sites.

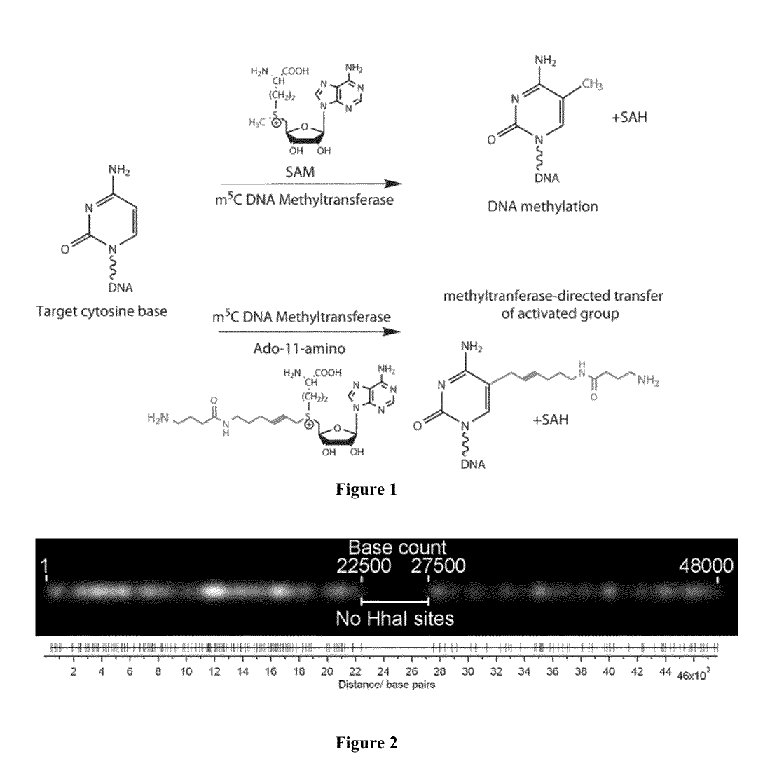

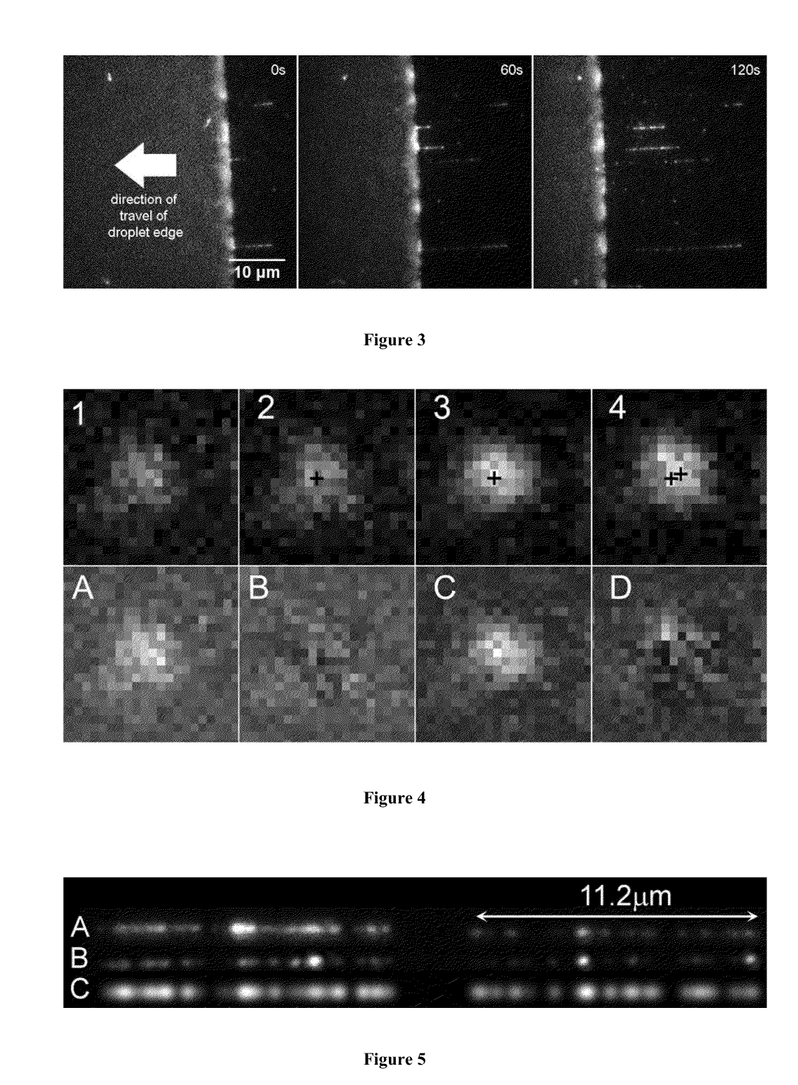

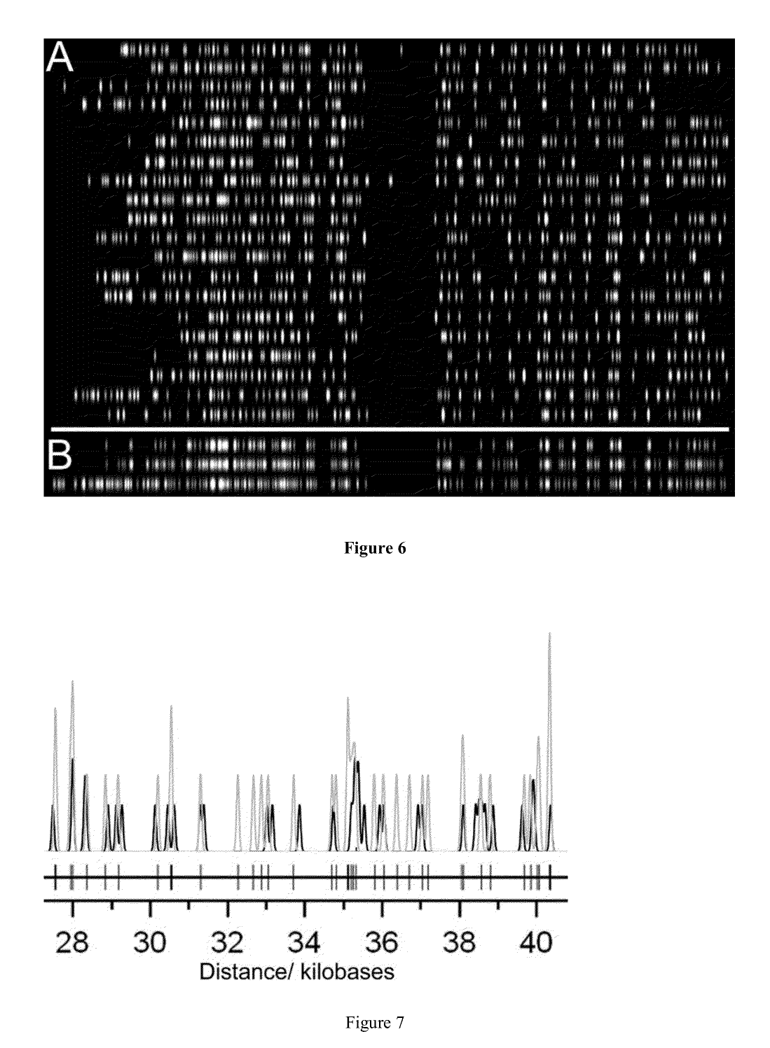

Some embodiments of the invention are directly below:

An embodiment of the present invention concerns a method for single-molecule optical polynucleotide mapping and sequencing, the method comprising generating a sequence-specifically labelled polynucleotide with high labeling density by 1) reacting said polynucleotide with methyltransferase to induce a covalent modification of polynucleotide at target locations determined by the specificity of the polynucleotide methyltransferase enzyme and by incubation of the polynucleotide and polynucleotide methyltransferase with a modified methyltransferase cofactor until a polynucleotide methyltransferase-catalyzed covalent attachment of a fluorescent or functional group to the polynucleotide is achieved which after purification may be incubated with a fluorescent or fluorophore label and whereby the fluorophore labels are photobleached (faded), photoswitchable or undergoing another stochastic photophysical process and fluorescence emission is quantified or measured. Preferably this method comprising generating of sequence-specifically labelled DNA with high labeling density by 1) reacting said DNA with methyltransferase to induce a covalent modification of DNA at target locations determined by the specificity of the DNA methyltransferase enzyme and by incubation of the DNA and DNA methyltransferase with a modified methyltransferase cofactor until a DNA methyltransferase-catalyzed covalent attachment of a fluorescent or functional group to the DNA is achieved which after purification may be incubated with a fluorescent or fluorophore label and whereby individual fluorophore labels along a linear polynucleotide, are isolated. Such isolation can be by a process whereby fluorophore labels are photobleached (faded), photoswitchable or undergoing another stochastic photophysical process and fluorescence emission is quantified or measured. In this context, according to a preferred embodiment of the above described method the density of labeling is tunable, depending on the methyltransferase enzyme used to carry out the reaction. According to a further preferred embodiment, in this method the DNA is derivatized by the HhaI DNA methyltransferase enzyme (M.HhaI), which recognizes the four-base sequence ′5′-GCGC-3′ and targets the central cytosine for modification at the C5-position, is used to direct the fluorescent labeling of the DNA and preferably the fluorescently labelled DNA is obtained from the resulting ‘derivatized DNA’ by incubating it with amine-reactive fluorophore (succinimidyl ester). This amine-reactive fluorophore can be xanthene dye, Atto647N. This DNA methyltransferase can be a DNA C5 cytosine methyltransferase. The DNA methyltransferase can be M.HhaI methyltransferase for instance M.HhaI variant Q82A/Y254S/N304A).and it can be in an equimolar amount to the target sites.

Preferably this polynucleotide with methyltransferase and a cofactor are incubated in an aqueous medium. This aqueous medium can be a buffer. According to one aspect the cofactor is a synthetically prepared cofactor. The cofactor is a derivative of s-adenosyl-L-methionine and the cofactor is preferably fluorescent. According to an aspect of the method of present invention the incubation time for the methyltransferase and the polynucleotide is minutes, for instance at least 10 min, or at least 20 min, or at least between 20 min and 50 minutes or greater than 50 minutes.

According to one aspect, in any of method of present invention the protein digestion is carried out for polynucleotide purification, preferably by Proteinase K or another protease with broad substrate specificity.

According to one aspect, in any of method of present invention the purified polynucleotide is incubated with a fluorescent label in a suitable molar excess. According to yet one aspect, in any of method of present invention the purified polynucleotide is incubated with a fluorescent label emitting in the red spectral range. The purified polynucleotide can be incubated with one of the following a red-emitting rhodamine dye, with ATTO-647N or with ATTO-647N NHS ester, with ATTO-647N NHS ester for instance in a 50 to 90 fold molar access or in a 70 to 80 fold molar access.

According to an aspect in the above described methods of present invention the purified labeled polynucleotide is linearized. Such linearization can be in a nanoslit or on the surface. For instance according to one aspect, in any of method of present invention the purified labeled polynucleotide is deposited on a surface for instance the purified labeled polynucleotide is deposited on a polymer coated surface. Particularly suitable is a PMMA coated surface. Such surface can be a coverslip and this coverslip can be PMMA-coated.

An important aspect of present invention is that 1) individual fluorophore labels along a linear polynucleotide, are isolated (e.g. by photobleaching, by photoswitching or by another stochastic photophysical process) and 2) the position of individual fluorophore labels is determined by a processor with software assisted measurement system and/or control algorithm adapted to measure the fluorescence emission signal followed by 3) translation of the aforementioned fluorophore label positions to a location on said polynucleotide by comparison of the image to one or more reference molecules or standards. Individual fluorophore label isolation along a linear polynucleotide can for instance be obtained by photophysical process such as photobleaching, by photoswitching. In this context, according to a preferred embodiment the method of any of the previous embodiments, comprises that the fluorophore labels are photobleached (faded); that the fluorophore labels undergo a stochastic process. For instance the fluorophore labels can be excited and fluorescence emission quantified or measured in relation to exposure time and intensity of excitation, for instance such excitation of the fluorophore labels can be by a laser. According to a preferred embodiment of the present invention, such fluorophore label is excited on a single DNA molecule and fluorescence emission quantified or measured. In an additional preferred embodiment the fluorophore label's emission is detected via an optical filter and an emission bandpass filter. In an embodiment, this emission signal is monitored in a processor with software assisted measurement system and/or control algorithm and in an embodiment, this processor has a computer readable medium tangibly embodying computer code executable on a processor. Furthermore this processor can comprise a memory for storing the information signals and at least one transmitter for transmitting processed information signals to a display means. In a preferred embodiment this stochastic process such as photobleaching (fading) of the fluorophore labels are recorded for instance filmed to produce a movie. According to an embodiment of the present invention, the record for instance film of the photobleaching of the fluorophore of a single polynucleotide is stored in the memory. Furthermore in an embodiment the processor comprises a program to fit the position of each of the fluorophores along a DNA molecule with sub-diffraction-limit precision. Hereby the processor can model and fit the emission from this last fluorophore (a diffraction-limited spot), for instance by using a two-dimensional Gaussian profile and by subtracting this emission from all previous frames in the movie, the emission of the penultimate emitter is resolved. Furthermore in an embodiment of the above described method of present invention the processor extracts the contribution of every emitter in the movie, hereby the integration times can be selected such to avoid that more than one emitter within a diffraction-limited spot bleaches simultaneously or to avoid photoblinking. Hereby the integration times can be selected based on the photophysical properties of the fluorophore. Furthermore the fluorophore positions or individual DNA molecules can be visualized to create a fluorocode.

In an embodiment of the method of present invention described above comprises fluorophore positioning which is convolved with a Gaussian point spread function to give the projected position of each of the fluorophores on a line, hereby the intensity profile along each fluorocode can be generated in order to align a fluorocode from an individual molecule (data) to another fluorocode and hereby the two intensity profiles can be aligned by laterally shifting and stretching one profile to fit the other profile, whereby for instance the stretching factor applied to the reference map is allowed to vary between 1.2 and 2.0 and whereby this and the lateral shift parameter are optimized by maximizing the output from the convolution of the two intensity profiles.

The invention further relates to monitoring the fluorophore positions or individual DNA molecules using computer software. In this context, according to a preferred embodiment the DNA labeling can be repeated to produce DNA labeled with more than one color of fluorophore.

According to a further preferred embodiment, in the method of present invention the polynucleotide is amplified by a DNA polymerase and the fluorocode of the amplified DNA is compared with that of the native genomic DNA to derive a map of the methylation status of the genomic DNA. In this context, according to a preferred embodiment the DNA is labeled using the DNA methyltransferase following deposition onto a surface or following alignment in a nanoslit.

In particular embodiments of present invention the fluorescence is measured using a technique with an optical resolution of less than 300 nm, or the fluorescence is measured using a technique with an optical resolution of between 200 nm and 300 nm, or the fluorescence is measured using a technique with an optical resolution of less than 100 nm and 200 nm, or the fluorescence is measured using a technique with an optical resolution of less than 100 nm. A particular system to measure the fluorescence is using stimulated emission depletion (STED)-microscopy. The fluorescence can be measured using near-field imaging methods.

According to various embodiment the methods or systems of present invention, has various uses. It can be used for any of the following uses: DNA profiling, for instance for forensic science; for genome assembly; for the study of copy number variations; for the study of the methylation status; for methylation profiling; for the study of heritable diseases; for the identification of viruses; for the identification of bacteria; for the identification of fungi; for the identification of plants; for the identification of eukaryotic specimens, including humans; for description of the DNA sequence, with a maximum achievable resolution of less than 20 bases.

Another aspect of present invention concerns a kit comprising a DNA methyltransferase, a DNA methyltransferase cofactor and a fluorophore label of any of the previous embodiments for carrying out any of the methods or uses of the previous embodiments. This kit can enable the deposition of DNA onto a surface that can subsequently be used to create a fluorocode. A particular embodiment of present invention is a software programme whereby a measured fluorescence signal from a single DNA molecule is converted into a fluorocode or a software programme whereby the fluorocodes from more than one DNA molecules are combined to produce a consensus fluorocode. Present invention can also be embodied by a database containing generated (reference) and experimentally derived fluorocodes. Such software programme of present invention can be used to compare and match an experimentally derived fluorocode with another fluorocode or several other fluorocodes from a database of reference fluorocodes.

In particular embodiments of present invention a microfluidic device is used to extract, purify and label DNA, directly from a cell and then deposit it stretched onto a surface or in nanochannels. For instance DNA can be linearized by fluidic devices with sub-micrometer dimensions for instance with a microchannel with an entropic trap or with an array of entropic traps for instance sub-100 nm constriction adapted to cause DNA molecules to be entropically trapped. The length-dependent escape of DNA from such trap enables a band separation of the DNA molecule(s). DNA with lengths can be moved electrokinetically into a nanofluidic nanoslit array. Such microchannel with an entropic trap can comprise alternating deeper (well) and shallower (nanoslit) regions to be more effective for separating DNA in the kbp range by entropic trapping and to linearize the DNA Particular suitable for containing nanoslits or nanoslit arrays are fused silica nanofluidic devices containing either nanoslit arrays to separate and linearize the specifically labeled polynucleotide under an electric field.

The embodiments herein were described in connection with a novel high resolution mapping technology for DNA. However, it is to be understood that the invention may additionally or alternatively be employed with other polymer or polynucleodide high resolution mapping applications.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

### REFERENCES TO THIS APPLICATION

1. Pushkarev, D., Neff, N. F. & Quake, S. R. Single-molecule sequencing of an individual human genome. Nat. Biotechnol 27, 847-852 (2009).
2. Harris, T. D. et al. Single-Molecule DNA Sequencing of a Viral Genome. Science 320, 106-109 (2008).
3. Eid, J. et al. Real-Time DNA Sequencing from Single Polymerase Molecules. Science 323, 133-138 (2009).
4. Feuk, L., Carson, A. R. & Scherer, S. W. Structural variation in the human genome. Nat Rev Genet. 7, 85-97 (2006).
5. Redon, R. et al. Global variation in copy number in the human genome. Nature 444, 444-454 (2006).
6. Walsh, T. et al. Rare Structural Variants Disrupt Multiple Genes in Neurodevelopmental Pathways in Schizophrenia. Science 320, 539-543 (2008).
7. Erdogan, F. et al. High frequency of submicroscopic genomic aberrations detected by tiling path array comparative genome hybridisation in patients with isolated congenital heart disease. Journal of Medical Genetics 45, 704-709 (2008).
8. Latreille, P. et al. Optical mapping as a routine tool for bacterial genome sequence finishing. BMC Genomics 8, 321-321
9. Michalet, X. et al. Dynamic Molecular Combing: Stretching the Whole Human Genome for High-Resolution Studies. Science 277, 1518-1523 (1997).
10. Samad, A. H. et al. Mapping the genome one molecule at a time-optical mapping. Nature 378, 516-517 (1995).
11. Meng, X., Benson, K., Chada, K., Huff, E. J. & Schwartz, D. C. Optical mapping of lambda bacteriophage clones using restriction endonucleases. Nat Genet. 9, 432-438 (1995).
12. Zhou, S. et al. A Single Molecule Scaffold for the Maize Genome. PLoS Genet. 5, e1000711 (2009).
13. Zhou, S. et al. Shotgun optical mapping of the entire Leishmania major Friedlin genome. Mol. Biochem. Parasitol 138, 97-106 (2004).
14. Zhou, S. et al. Validation of rice genome sequence by optical mapping. BMC Genomics 8, 278 (2007).
15. Gad, S. et al. Bar code screening on combed DNA for large rearrangements of the BRCA1 and BRCA2 genes in French breast cancer families. Journal of Medical Genetics 39, 817-821 (2002).
16. Qu, X., Wu, D., Mets, L. & Scherer, N. F. Nanometer-localized multiple single-molecule fluorescence microscopy. Proceedings of the National Academy of Sciences of the United States of America 101, 11298-11303 (2004).
17. Jo, K. et al. A single-molecule barcoding system using nanoslits for DNA analysis. Proc. Natl. Acad. Sci. U.S.A 104, 2673-2678 (2007).
18. Xiao, M. et al. Rapid DNA mapping by fluorescent single molecule detection. Nucl. Acids Res. 35, e16 (2007).
19. Klimasauskas, S. & Weinhold, E. A new tool for biotechnology: AdoMet-dependent methyltransferases. Trends in Biotechnology 25, 99-104 (2007).
20. Dalhoff, C., Lukinavicius, G., Klimasauskas, S. & Weinhold, E. Direct transfer of extended groups from synthetic cofactors by DNA methyltransferases. Nat Chem Biol 2, 31-32 (2006).
21. Lukinavicius, G. et al. Targeted Labeling of DNA by Methyltransferase-Directed Transfer of Activated Groups (mTAG). Journal of the American Chemical Society 129, 2758-2759 (2007).
22. Roberts, R. J., Vincze, T., Posfai, J. & Macelis, D. REBASE—a database for DNA restriction and modification: enzymes, genes and genomes. Nucleic Acids Res 38, D234-236 (2010).
23. Wang, W., Lin, J. & Schwartz, D. Scanning Force Microscopy of DNA Molecules Elongated by Convective Fluid Flow in an Evaporating Droplet. Biophysical Journal 75, 513-520 (1998).
24. Kim, J. H., Shi, W. & Larson, R. G. Methods of Stretching DNA Molecules Using Flow Fields. Langmuir 23, 755-764 (2007).
25. Liu, Y. et al. Ionic effect on combing of single DNA molecules and observation of their force-induced melting by fluorescence microscopy. J. Chem. Phys. 121, 4302-4309 (2004).
26. Yildiz, A. et al. Myosin V walks hand-over-hand: single fluorophore imaging with 1.5-nm localization. Science 300, 2061-2065 (2003).
27. Thompson, R. E., Larson, D. R. & Webb, W. W. Precise nanometer localization analysis for individual fluorescent probes. Biophys J 82, 2775-2783 (2002).
28. Heilemann, M. et al. Subdiffraction-Resolution Fluorescence Imaging with Conventional Fluorescent Probes 13. Angewandte Chemie International Edition 47, 6172-6176 (2008).
29. Rust, M. J., Bates, M. & Zhuang, X. Sub-diffraction-limit imaging by stochastic optical reconstruction microscopy (STORM). Nat Meth 3, 793-796 (2006).
30. Heilemann, M., Dedecker, P., Hofkens, J. & Sauer, M. Photoswitches: Key molecules for subdiffraction-resolution fluorescence imaging and molecular quantification. Laser & Photonics Review 3, 180-202 (2009).
31. Dedecker, P. et al. Defocused Wide-field Imaging Unravels Structural and Temporal Heterogeneity in Complex Systems. Advanced Materials 21, 1079-1090 (2009).
32. Muls, B. et al. Direct Measurement of the End-to-End Distance of Individual Polyfluorene Polymer Chains 13. ChemPhysChem 6, 2286-2294 (2005).
33. Ottink, O. M.; Nelissen, F. H.; Derks, Y.; Wijmenga, S. S.; Heus, H. A. Analytical Biochemistry 2010, 396, 280-283.

1.-47. (canceled)

48. A method for sub-diffraction limit precision mapping of a polynucleotide, e.g. a DNA, the method comprising:
sequence-specifically labeling the polynucleotide, said labeling comprising reacting the polynucleotide with a polynucleotidemethyltransferase enzyme and a methyltransferase cofactor, and subsequently incubating the polynucleotide with a fluorophore,
isolating the emission from individual fluorophores along the polynucleotide, said isolating comprising recording a movie of the fluorescence emission signal of said fluorophores while undergoing photobleaching, photoswitching or another stochastic photophysical process, and
determining the positions of the individual fluorophores with sub-diffraction limit accuracy by a processor with one of or both software assisted measurement system and control algorithm configured to measure said fluorescence emission signal, followed by
translating said positions of the individual fluorophores to sequence-specific locations on said polynucleotide by comparison of an image of the positions of the individual fluorophores to one or more reference molecules or standards.

49. The method according to claim 48, wherein said translating comprises creating said image by convolving the positions of the individual fluorophores with a Gaussian point spread function and determining an intensity profile along a longitudinal axis of the polynucleotide molecule in said image, said translating furthermore comprising shifting and stretching said intensity profile to fit a further intensity profile corresponding to said reference molecule or standard.

50. The method according to claim 48, wherein determining the positions by a processor comprises fitting the position of each of the fluorophores along the polynucleotide (e.g. DNA) molecule with sub-diffraction-limit precision making use of the fact that their emission can be isolated and localized as a result of a stochastic process such as photobleaching or photoswitching.

51. The method according to claim 48, wherein determining the positions by a processor comprises modelling and fitting the emission from a fluorophore.

52. The method according to claim 48, wherein determining the position by a processor comprises modelling and fitting the fluorescence emission signal from a fluorophore using a two-dimensional Gaussian profile.

53. The method according to claim 48, wherein determining the position by a processor comprises determining the contribution of the fluorescence emission signal in the movie corresponding to each fluorophore.

54. The method according to claim 48, wherein the fluorophore positions or individual polynucleotide (e.g. DNA) molecules are visualized to create a fluorocode and to generate an intensity profile along each fluorocode in order to align a fluorocode from an individual molecule (data) to another fluorocode.

55. The method according to claim 48, wherein a stretching factor is allowed to vary between 1.2 and 2.0 and said stretching factor and a lateral shift parameter are optimized by maximizing the output from the convolution of said intensity profile and said further intensity profile.

56. The method according to claim 48, wherein the fluorophore labels are excited and fluorescence emission quantified or measured in relation to exposure time and intensity of excitation.

57. The method according to claim 48, wherein the sequence specifically fluorophore labeled polynucleotide comprises high density fluorophore labeling which concerns a fluorophore positioned every x bases, whereby x is between 300 and 10 bases.

58. The method according to claim 48, wherein the DNA polynucleotide is amplified by a DNA polymerase and the fluorocode of the amplified DNA is compared with that of the native genomic DNA to derive a map of the methylation status of the genomic DNA.

59. The method according to claim 48, wherein the methyltransferase has been mutated to alkylate DNA using an unlabeled analogue of s-adenosyl-L-methionine.

60. The method according to claim 48, wherein the sequence-specifically labeled polynucleotideis deposited on a PMMA coated surface such that the polynucleotide molecule is extended beyond its solution phase contour length.

61. The method according to claim 48, including multi-color labeling of the polynuceotide using two or more methyltransferases.

62. The use of the method according to claim 48 for DNA profiling.

63. The use of the method according to claim 48 for genome assembly.

64. The use of the method according to claim 48 for the study of copy number variations.

65. The use of the method according to claim 48 for the study of a methylation status.

66. The use of the method according to claim 48 for the study of heritable diseases.

67. A polynucleotide molecular diagnostic testing apparatus, adapted for carrying out the method according to claim 48.
